(19) United States
(12) Patent Application Publication
(10) Pub. No.: US 2006/0225353 A1
(43) Pub. Date: Oct. 12, 2006

(54) Rotatable window pane assembly and method of repositioning

(76) Inventor: Evyatar Erell, (US)

Correspondence Address: FOGG AND ASSOCIATES, LLC, P.O. BOX 581339, MINNEAPOLIS, MN, 55458-1339, US

(21) Appl. No.: 10/500,545

(22) PCT Filed:
(86) PCT No.: PCT/IL03/00004

(30) Foreign Application Priority Data
Jan. 3, 2002 (IL) 14757

(51) Int. Cl. E05D 15/48

(52) U.S. Cl. 49/169

(57) ABSTRACT

A rotatable window pane assembly and method of repositioning the same is disclosed in which the window pane assembly comprising a frame and at least one window pane is rotatably supported in a fixed frame from a first position, such that the at least one window pane is parallel to an aperture defined by the fixed frame, to a second position, such that the at least one window pane is parallel to the aperture defined by the frame and a second surface of the at least one window pane faces the outside, or from a second to first position. A seal assembly comprising a seal frame and at least one pliable seal carried is located on the inside with respect to the fixed frame and is pivotally displaceable independently of the position of the window pane assembly, from a closed position in which the seal frame is parallel and adjacent to the aperture defined by the interior surface of the fixed frame to an open position in which the seal frame is spaced from and at an angle to the aperture.

### FIELD OF THE INVENTION

The present invention relates to the field of fenestration. More particularly, the invention relates to a method and apparatus for rotating a waterproof window pane assembly 360 degrees with respect to a fixed frame, wherein the thermal and optical performance of the window pane assembly depends on the orientation of the glass surfaces contained therein. The rotatable window pane assembly also allows for improved accessibility to the exterior face of the glass surfaces of conventional windows to enable the cleaning thereof.

### BACKGROUND OF THE INVENTION

Glazed openings permit the flow of energy between an interior and an exterior by conduction, convection and radiation. Ordinary, nearly transparent, standard double-strength sheet glass allows about 87% of the solar radiation (ASHRAE (1989), 1989 Fundamentals Handbook, ASHRAE, Atlanta) to pass. The uncontrolled influx of solar energy through large glazed openings has numerous drawbacks, for example: 1) extreme overheating in the summer; and 2) visual discomforts of glare both in summer and in winter. Furthermore, direct sunlight has a deleterious effect on furniture and objects located near the opening.

The traditional response to these problems has been to incorporate shading devices, which reduce the exposed area of the glazing.

Fixed shading devices are generally installed on the exterior of the windows. Usually they do not require maintenance, but they cannot be adapted to changing meteorological conditions, and, while screening out direct solar radiation, have little effect on diffuse or reflected radiation.

Operable shading devices on the exterior of windows are designed to allow control of the incoming radiation at all times. They may have complex mechanisms which require maintenance or replacement, and require either user intervention to operate properly, or expensive automatic control systems.

The effect of shading devices installed on the interior of the building, such as roller shades, curtains or venetian blinds, depends on their ability to reflect incoming solar radiation back through the window before it can be absorbed and converted to heat. Drapes may reduce annual cooling loads by 5-20% (Rudoy & Duran, 1975, “Effect of Building Envelope Parameters on Annual Heating/Cooling Load”, ASHRAE Journal 7:19), and serve mainly to improve visual comfort and reduce the effect of radiant energy on building occupants near the windows. Integrated shading devices, i.e. venetian blinds placed between glass sheets in a double glazed unit or between the frames of a double window, are also in use.

All shading devices interfere with one of the main purposes of windows—the provision of visual contact with the outdoors; and since their response is based on simple geometry, they are not selective in their effect. They either block out all of the incident radiation or allow it to pass through a given element of the window. The limitations of shading devices led to the development of new types of glazing materials. Modern glazing design involves the use of multiple panes of glass, with panes of differing properties combined in one window assembly. Selective transmission of light and heat may be achieved in response to changing environmental conditions. The annual energy consumption for a given enclosure may be reduced, with a concomitant improvement in illumination, by reversing the relative position of each window pane during specific periods of the year.

Reversible windows for solar heating and cooling are well known in the art. For example, U.S. Pat. No. 3,925,945 discloses a glass wall assembly having a pivotally mounted frame which carries a pane of heat absorbing glass spaced from an insulating panel comprised of panes of clear glass. The heat energy absorbed by the glass may be converted into convective heat and conducted to the outside of the building during the summer months or to the interior during the winter months, after the glass wall assembly has been reversed so that the insulating panel faces the exterior side.

U.S. Pat. No. 4,365,620 discloses a window which comprises a first pane that blocks infrared radiation and a second pane that transmits it and can be rotated about a horizontal axis so that the first pane faces outwardly in the summer and the second pane faces outwardly in the winter. Similarly, European Publication No. EP 922829 teaches a reversible ventilated glazing system.

Although the aforementioned patents teach windows in which the orientation of the panes is reversible, the windows are nevertheless not capable of being reversed quickly and easily. They cannot be rotated on a daily basis or for a short period of time to allow for convenient and cost-effective washing of both faces of a glass window from the building interior. In order for a prior art window to be water impermeable, a sealing element such as a gasket has to be permanently affixed between the pivotally mounted frame, which carries the window, and the wall in which the frame is mounted. The sealing element therefore has to be removed, e.g. with a hand-held implement, in a time-consuming procedure. Alternatively, if the sealing element is not permanently affixed, absolute sealing is not effected due to air pockets that remain between the sealing element and the external wall. A clearance between the sealing element and the external wall, when a permanent gasket is not affixed, must be maintained to allow for the rotation of the pivotally mounted frame.

U.S. Pat. No. 4,521,991 discloses a window apparatus that includes a pair of window frame assemblies which are capable of sliding and inwardly tilting relative to a jamb assembly, thereby facilitating opening and indoor cleaning. The window frames are provided with locking members to prevent tilting, and the window apparatus can withstand relatively high wind loads encountered on the upper floors of a high building due to the low stress of the locking members. Even though this window apparatus can be used for indoor window cleaning at a high level, it is not adaptable for reversing the orientation of the window panes.

All the structures described above do not allow for the reversing of the relative position of each window pane during specific periods of the year in an immediate and simple manner, while maintaining the window pane assembly impervious to water and gusts of wind in either orientation.

It is an object of this invention to provide a window pane assembly comprised of panes having different optical properties.

It is an additional object of this invention to provide a method and apparatus for effortlessly and speedily reversing the relative position of the window panes during specific periods of the year, such that the window pane assembly is impervious to water and gusts of wind in either orientation.

It is an additional object of the present invention to provide a method and apparatus for a window pane assembly that allows for indoor window washing of both sides of each pane retained in the assembly, regardless of the height above ground level.

It is yet an additional object of this invention to provide a cost-effective window apparatus.

Other objects and advantages of the invention will become apparent as the description proceeds.

### SUMMARY OF THE INVENTION

The present invention relates to a window apparatus comprising:

i. a fixed frame having an interior surface which defines an aperture;

ii. a window pane assembly comprising a frame and at least one window pane mounted in said frame, said pane having a first and a second surface, said window pane assembly being rotatably supported in said fixed frame and being rotatable with respect to said fixed frame from a first position wherein said at least one window pane is parallel to said aperture defined by said fixed frame and wherein said first surface of said at least one window pane faces the outside to a second position wherein said at least one window pane is parallel to said aperture defined by said window frame and said second surface of said at least one window pane faces the outside, said window pane assembly being further rotatable from said second to said first position; and

iii. a seal assembly comprising a seal frame and at least one pliable seal carried by and exteriorly positioned with respect to said seal frame, said seal assembly being located on the inside with respect to said fixed frame and sealing said aperture from the inside, being hingedly supported in said fixed frame, and being pivotally displaceable independently of the position of said window pane assembly from a closed position in which said seal frame is parallel and adjacent to said aperture defined by said interior surface of said fixed frame to an open position in which said seal frame is spaced from and at an angle to said aperture.

Preferably, a pliable seal of the seal assembly, when the frame thereof is in the closed position, is in compressed engagement with both the interior of said fixed frame and with said window pane assembly, whereby to provide a water impermeable seal.

The window pane assembly may be manually rotated or remotely rotated by an actuating means.

As referred to herein, the terms “outside”, “inside”, “interior” and “exterior” relate to the structure in which the window is mounted. Thus, if the window is mounted in a wall or skylight or other surface of a building, the spaces within the building constitute the inside and the space about and above the building constitute the outside.

In a preferred embodiment, the window apparatus further comprises a glazing unit hingedly attached to the window pane assembly, said glazing unit being provided with at least one pane of glass parallel to, when in a closed position, and having different optical properties than the at least one pane carried by the window pane assembly, whereby said glazing unit is rotatable together with the window pane assembly, so that said glazing unit is exteriorly disposed at said first position and interiorly disposed at said second position relative to the at least one pane carried by the window pane assembly.

In a winter mode, the at least one pane of glass, provided with the glazing unit, which is preferably capable of absorbing solar radiation, faces the inside. Solar radiation between 0.3-4 microns is transmitted through the at least one pane carried by the window pane assembly, which is clear and faces the outside. The at least one pane of glass provided with the glazing unit is capable of partially absorbing 30-90 percent of the energy of the incoming solar radiation, depending on local climatic conditions. The at least one pane of glass provided with the glazing unit is consequently heated and subsequently releases energy to the inside by long-wave radiation or by convective heating. At least one gap is formed between the at least one pane carried by the window pane assembly and the at least one pane of glass provided with the glazing unit, whereby heated air is able to circulate through said gap into an enclosure proximate to the window apparatus. Space heating is thereby achieved, while significantly reducing visual discomfort and damage to furnishings.

In a summer mode, the window pane assembly is rotated so that the at least one pane of glass provided with the glazing unit faces the outside. Most of the short wave solar radiation between 0.3-4 microns is absorbed by the at least one pane of glass provided with the glazing unit, and is prevented from being transmitted to the inside, through the at least one pane carried by the window pane assembly, since the at least one pane of glass provided with the glazing unit is nearly opaque to a wavelength greater than 4 microns. While being heated, the energy absorbed by the at least one pane of glass provided with the glazing unit is released to the outdoors by convection or by long wave radiation. Therefore, overheating of the inside is prevented and visual comfort is improved.

The present invention also relates to a method of repositioning a window pane assembly, comprising providing a window pane assembly which carries at least one window pane and which is rotatable with respect to a fixed frame; providing a mounting for a water impermeable sealing element hingedly attached to the interior of the frame; opening said mounting; applying a force to said window pane assembly to thereby displace the latter from a first position at which one side of said at least one window pane is parallel to and facing a plane formed by the exterior of the frame to a second position at which the other side of said at least one window pane is parallel to and facing a plane formed by the frame exterior, or from said second position to said first position; and closing said mounting.

This method allows for the washing of windows indoors, which is particularly advantageous at the upper floors of a high building for which outdoors window washing is a costly and dangerous task.

In a preferred embodiment of the invention, the method further comprises providing a glazing unit hingedly attached to the window pane assembly and which is provided with a pane of glass parallel to when in a closed position and having different optical properties than the at least one pane carried by the window pane assembly and rotating said glazing unit when in a closed position, together with the window pane assembly, from the first position to the second position, or vice versa.

This method enhances winter heating and summer cooling. The glazed unit preferably faces the frame exterior during the summer months to prevent the influx of solar radiation and preferably faces the frame interior during the winter months.

In one aspect, the window pane assembly is rotated by means of a microprocessor to facilitate rotation of the window pane assembly from the first position to the second position, or vice versa, in response to predetermined sensed conditions of illumination and/or temperature.

### BRIEF DESCRIPTION OF THE DRAWINGS

In the drawings:

FIG. 1 is a perspective view of a first embodiment of the window apparatus of the invention in which a window pane assembly is in an intermediate position;

FIG. 2 is a perspective view of the window apparatus of FIG. 1 in which the window pane assembly is in a closed position;

FIG. 3 is a vertical cross section of the window apparatus of FIG. 2 taken on plane A-A;

FIG. 4 is a horizontal cross section of the window apparatus of FIG. 2 taken on plane B-B;

FIG. 5 is a perspective view of a window apparatus according to a second embodiment of the invention, in which the glazing unit is shown in an open position;

FIG. 6 is a perspective view of the window apparatus of FIG. 5 in which the window pane assembly is in a closed position;

FIG. 7 is a vertical cross section of the window apparatus of FIG. 6 taken on plane C-C; and

FIG. 8 is a horizontal cross section of the window apparatus of FIG. 6 taken on D-D.

### DETAILED DESCRIPTION OF PREFERRED EMBODIMENTS

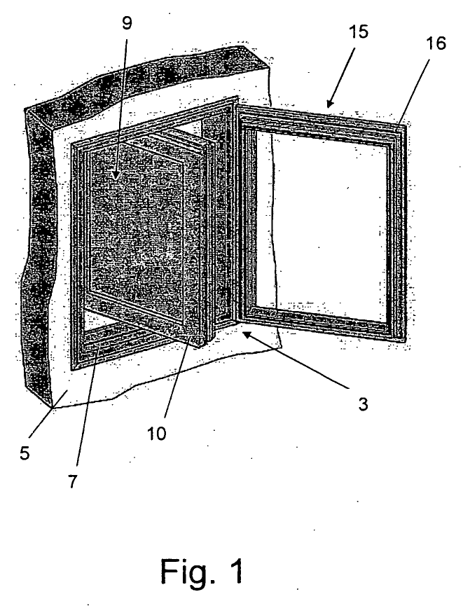

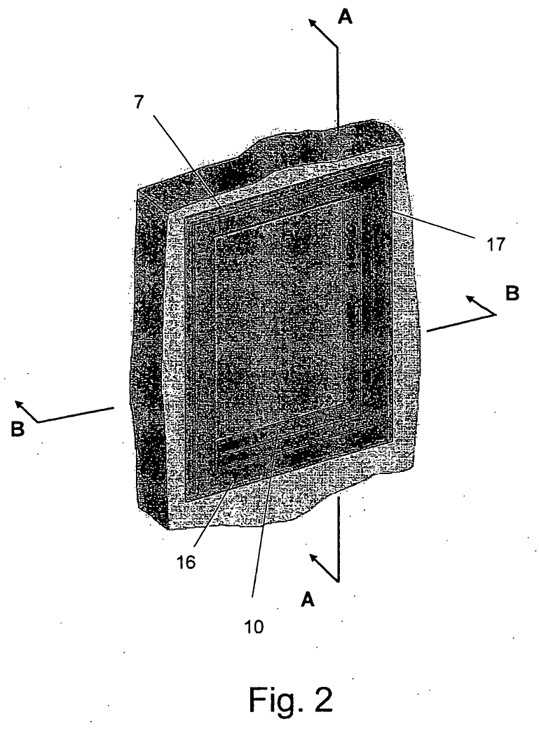

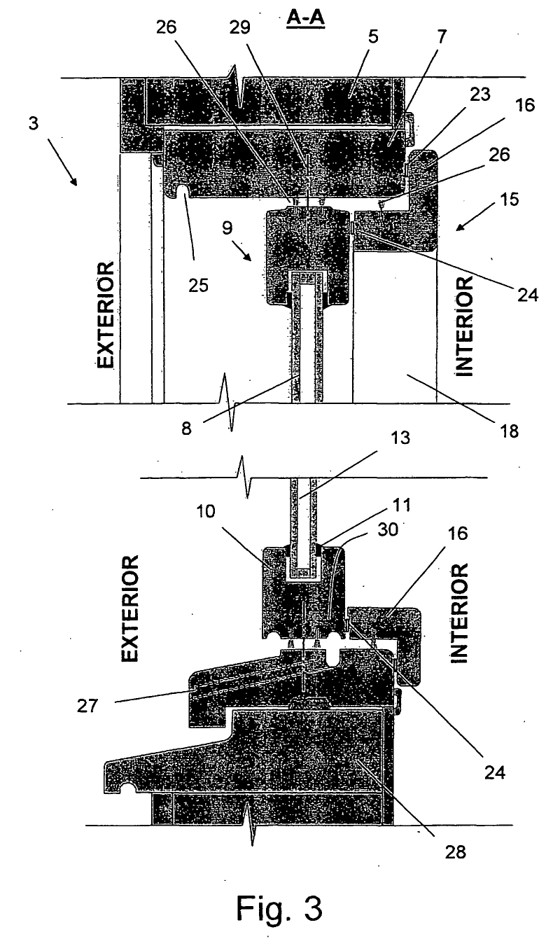

FIGS. 1-4 relate to one preferred embodiment of the window apparatus, generally designated by 3. As shown in FIG. 1, fixed frame 7 is permanently attached to wall 5 of the structure that supports window apparatus 3. A window pane assembly, generally designated by 9, is rotatably displaceable about an axle (not shown) with respect to fixed frame 7, wherein the axle is pivotally mounted in the latter. The axle may be mounted in a vertical disposition, as depicted in the drawing by the rotational direction of window pane assembly 9, or in a horizontal disposition. As shown in FIGS. 2 and 3, seal assembly 15 comprising seal frame 16 and seals 23, 24 is pivotally attached, e.g. by means of hinges 17, to the interior side of fixed frame 7. When seal assembly 15 is closed, frame 16 thereof is parallel with, and pressed against, frame 10 of the window pane assembly.

Fixed frame 7, window pane assembly 9 and seal assembly 15 are rectangularly shaped. It is clear that the actual size and shape of the window apparatus are not critical, and the configuration of the present invention may be applied, mutatis mutandis, to any other size or shape. Similarly the frames shown, namely fixed frame 7, window frame 10, and seal assembly frame 16 or any other number of frames employed, may be fabricated from wood, aluminum, steel, plastic, or any other suitable material, alloy or mixtures thereof.

For clarity, the following description relates to a window apparatus that is installed within an external wall of a building. It is understood, however, that the window apparatus of the present invention may also be advantageously adapted to a structure having any particular inclination, and therefore may also be used for a skylight.

As shown in FIG. 3, window pane assembly 9 includes at least one window pane 8, and preferably consists of a double-glazed unit. Each pane 8 is retained in a substantially vertical position by frame 10. Gasket 11 provides an airtight and watertight seal.

Seal assembly 15 comprises supporting frame 16 as well as seals 23 and 24 affixed to the entire periphery of frame 16. Frame 16 is unglazed to allow for accessibility to the interior face of pane 8. Frame 16 has an L-shaped cross section, to allow for greater structural rigidity and for the mounting thereon of the compressive seals. Seal 23 is engageable with fixed frame 7 and seal 24 is engageable with window pane assembly 9.

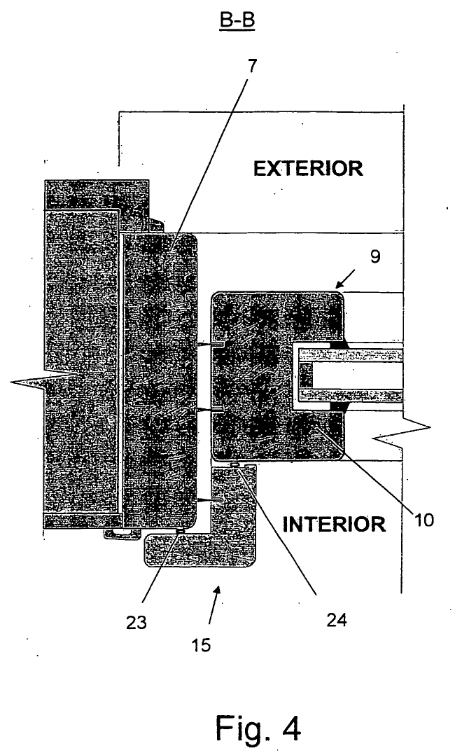

Seal assembly 15 is hingedly attached to fixed frame 7 by means of hinges 17, which are located at the inside with respect to the pane assembly. The seal assembly 15 may be hinged to any of the four sides of fixed frame 7, and may be conveniently opened and closed with a handle (not shown), or with any other opening means. When in a closed position, seal 24 is in compressed engagement with the interior side of frame 10 of the window assembly, and seal 23 is in compressed engagement with the interior side of fixed frame 7. As shown further in FIG. 4, seal 23 is more outwardly positioned, that is closer to frame 16, than seal 24. Therefore seal 23 will prevent the passage of any water which may have collected between window pane assembly 9 and seal mounting 15, thereby providing the window apparatus with a water impermeable seal. The water impermeability is further enhanced by water drips 25 formed within fixed frame 7, frame 10 of the window pane assembly and sill 28, and by drainage channel 30 formed in the bottom portion of fixed frame 7. Drainage hole 27 drains the water that collects into drainage channel 30, e.g. from a complementary water drip 25 formed in the underside of frame 10 (see FIG. 3). Sill 28 is disposed underneath fixed frame 7. Frames 10 and 16 are provided with brush seals 26, which resiliently contact fixed frame 10, to restrict the passage of air.

Operationally, window pane assembly 9 may be rotated only after seal assembly 15 has been opened. After applying a force to window pane assembly 9, which in the illustrated example is provided with two window panes, the window pane assembly is rotated. The axis about which window pane assembly 9 rotates is indicated in FIG. 3 by 29. The window pane assembly is continuously rotatable by 360 degrees since fixed frame 7 has a contour with no protrusions which would resist or interfere with such a rotation.

In order to wash both window panes 8, window pane assembly 9 needs to be displaced from a first position, at which one of the panes is parallel to and faces the exterior of fixed frame 7, to a second position at which the other pane is parallel to and faces the exterior of fixed frame 7. Similarly window pane assembly 9 at times needs to be displaced from the second position to the first position. Window pane assembly 9 is configured to come as close as possible to fixed frame 7 during rotation without contact therewith. For example, a gap of only 7 mm is needed for a 120-cm wide window pane assembly to rotate within a fixed frame having a width of 100 cm. After closing seal assembly 15, whereby seal 23 is in compressed engagement with fixed frame 7, seal assembly 15 may be latched shut by means of a latch (not shown) that connects frame 16 and fixed frame 7 to prevent the opening of assembly 15 due to gusts of wind. These operations allow to carry out the washing of the windows indoors, which is particularly advantageous at the upper floors of a high building for which washing windows from the outside is a costly and dangerous task.

Window pane assembly 9 may be manually rotated by exerting a force on frame 10. Window pane assembly 9 may be remotely rotated by an actuating means, such as when the window panes are massive or when strong winds are blowing. The actuating means (not shown), e.g. a motor, may communicate with the axle(s), or may be provided with any other configuration that applies a moment to window pane assembly 9.

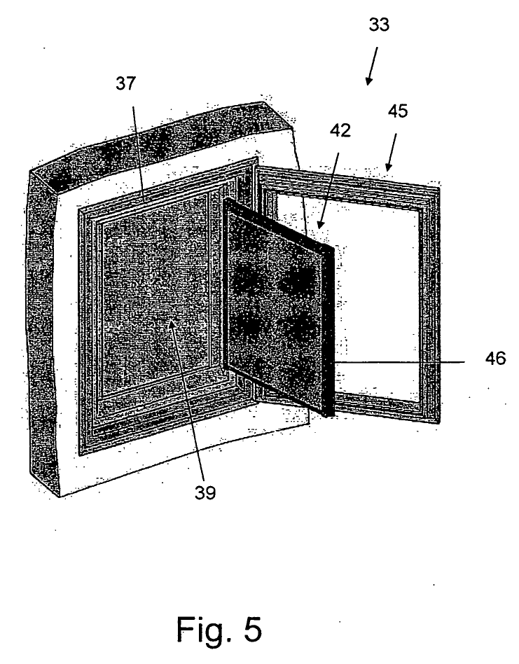

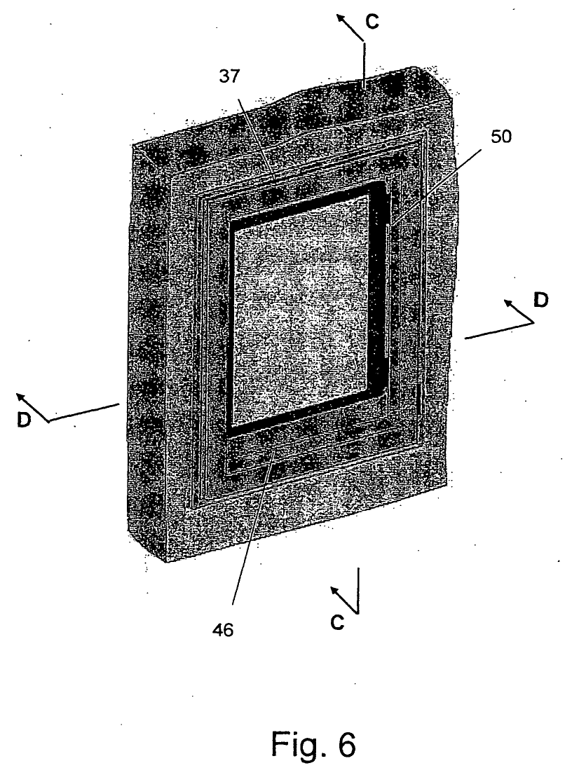

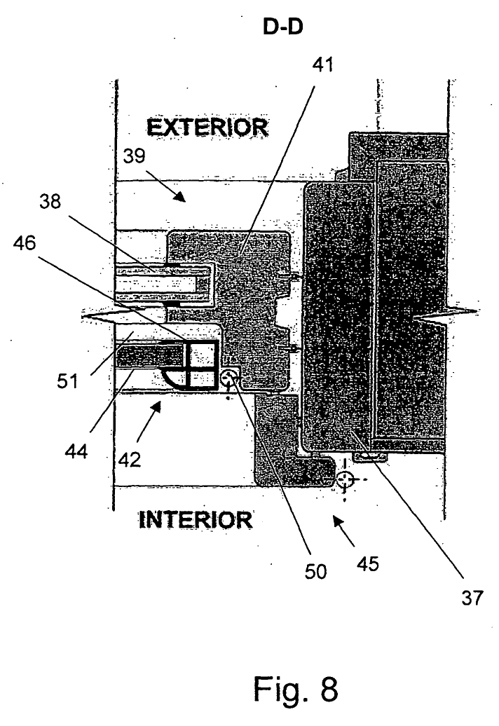

FIGS. 5-8 relate to a second preferred embodiment of the present invention, in which window apparatus 33 is provided with glazing unit 42. Since most of the components of window apparatus 33 are identical to those of window apparatus 3, described hereinbefore with reference to FIGS. 1-4, fixed frame 37, window pane assembly 39 and seal assembly 45 need not be described. FIG. 5 shows glazing unit 42 in an open position, and FIG. 6 shows glazing unit in a closed position.

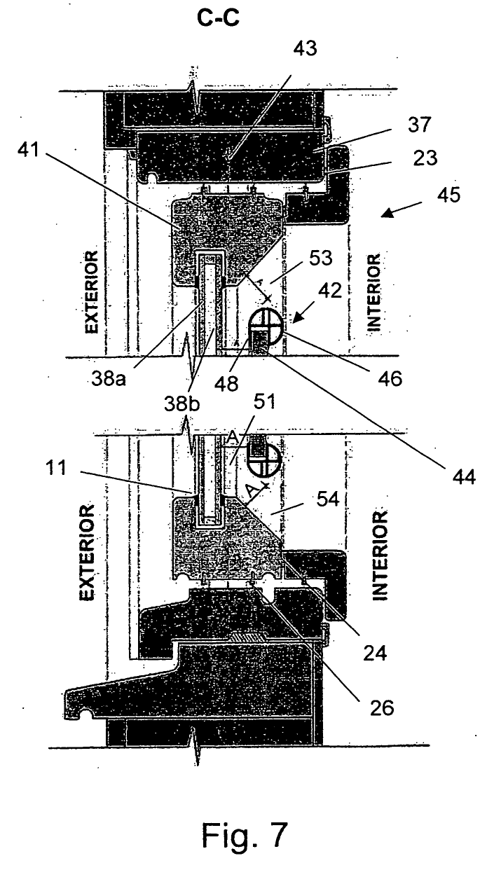

FIG. 7 illustrates glazing unit 42, which is provided with pane of glass 44 having different optical properties than each pane 38 carried by window pane assembly 39. Pane 44 may be secured, inter alia, by fixture 46 having e.g. a circular cross section and extending outward from the entire periphery of pane 44. Fixture 46 is fabricated with two planar extensions 48, one of which is disposed at each side of pane 44 and preferably bonded thereto at each edge thereof for support.

Rotatable frame 41 of window pane assembly 39 in this embodiment is thicker than that that of frame 10 shown in FIG. 3, so as to allow for the placement of glazing unit 42 therein. Panes(s) 38 are laterally offset from axle(s) 43 about which window pane assembly 39 rotates. The vertical height, that is the dimension parallel to axle(s) 43, of panes(s) 38 is greater than that of pane 44, and consequently the height of the cavities into which panes(s) 38 and pane 44, respectively, are insertable is also different.

As shown, glazing unit 42 is hingedly attached to window pane assembly 39 by hinges 50. Window pane assembly 39 is provided with a cavity whose periphery corresponds to the dimensions of frame 46 of glazing unit 42, as illustrated in FIG. 5, so as to allow for the fixation of glazing unit 42 when closed by providing a small clearance between fixture 46 and rotatable frame 41. A latch (not shown) is preferably provided to secure glazing unit 42 to rotatable frame 41 when the glazing unit is exteriorly positioned and exposed to a high wind load. When in a closed position, pane 44 of the glazing unit is parallel to pane(s) 38 of the window pane assembly. As a result, glazing unit 42, when in a closed position, rotates together with window pane assembly 39, from the first position to the second position thereof, or vice versa.

Glazing unit 42 enhances winter heating and summer cooling. The glazed unit may be advantageously repositioned by rotating window pane assembly 39 to a winter mode or a summer mode. In a summer mode, glazing unit 42 is exteriorly positioned with respect to window pane assembly 39, such that pane 44 absorbs most of the solar radiation and prevent its transmission through clear pane(s) 38 to the interior. After being heated, pane 44 dissipates the energy absorbed to the outdoors by convection and by long wave radiation. In a winter mode, the glazing unit is interiorly positioned with respect to pane(s) 38, as shown in FIG. 7. After being transmitted through pane(s) 38, solar radiation is absorbed by pane 44. As a result pane 44 is heated, releasing the energy to the interior by long wave radiation and by convection. The provision of glazing unit 42 significantly reduces any damage to furnishings by solar radiation. In both the winter and summer modes, pane(s) 38 and pane 44 are mutually parallel.

Air channel 51 is formed between pane(s) 38 and pane 44, due to the lateral spacing between the two sets of panes. This air channel enhances air circulation around absorptive pane 44 and into the building interior. Since the height of pane 44 is less than that of pane(s) 38, upper gap 53 and lower gap 54 are formed by the vertical spacing between rotatable frame 41 and glazing unit 42. During the winter mode, tinted pane 44 of the glazing unit absorbs most of the solar radiation that is transmitted through clear pane(s) 38. Pane 44 is therefore heated, following which air channel 51 is heated. The heated air then circulates through upper gap 53 and through the opening defined by the frame of the seal assembly into the enclosure. In the summer mode, pane 44 is exteriorly positioned with respect to pane(s) 38 and directs the heated air through gap 53 to the outside. It would be appreciated that even though air channel 51 and gap 53 provide a means of air circulation into the enclosure during the winter mode, the window apparatus nevertheless is airtight. Gaskets 11 which secure pane(s) 38 to the window pane assembly, brush seals 26 and seals 23, 24 prevent the infiltration of outside air, such as during gusts of wind or during a sandstorm, in both the summer and winter modes.

Window washing can be performed as follows: According to the example of the window apparatus shown in FIG. 7, two panes 38a and 38b are provided in window pane assembly 39 and one glazing unit pane 44 are employed. The number of panes shown in the figures was chosen for clarity, and it is clear that any number of panes can be employed in both the window pane assembly and in the glazing unit, without any loss in efficacy or ease in repositioning. In the winter mode, in which glazing unit 42 is facing the inside, the interior face of pane 44 is washed first. Glazing unit 42, which is hingedly attached to window pane assembly 39, is then opened, exposing the exterior face of pane 44 and the interior face of pane 38b for washing. Pane 44 is then closed and secured. If the exterior face of pane 38a requires washing, seal assembly 45 is then opened and window pane assembly 39 is rotated 180 degrees to facilitate its washing by a person located within the enclosure. After being washed, window pane assembly 39 is rotated another 180 degrees, so that pane 38a is once again exteriorly positioned, and seal assembly 45 is then closed and secured to provide a weatherproof seal. In the summer mode in which tinted pane 44 is exteriorly positioned with respect to pane(s) 38, the steps are reversed.

In addition to the other methods of rotation described hereinbefore in relation to the embodiment of FIG. 1, window pane assembly 39 may also be automatically rotated by a microprocessor-controlled window apparatus (not shown). During those days, in which it is would be advantageous to reposition the window pane assembly at least once a day, that is to change the relative location of glazing unit 42 with respect to panes 38a and 38b, to maximize comfort and energy savings, the repositioning is controllable by means of a microprocessor-controlled window apparatus. Such an apparatus may receive input from light and heat sensors disposed at predetermined locations relative to the window pane assembly. By example, if the temperature gradient between two of these sensors is greater than a predetermined value, the seal assembly is opened, e.g. by means of a pneumatic actuator, and the window pane assembly is rotated 180 degrees, after which the seal mounting is closed.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A window apparatus comprising:
a) a fixed frame having an interior surface which defines an aperture;
b) a window pane assembly comprising a frame and at least one window pane mounted in said frame, said pane having a first and a second surface, said window pane assembly being rotatably supported in said fixed frame and being rotatable with respect to said fixed frame from a first position wherein said at least one window pane is parallel to said aperture defined by said fixed frame and wherein said first surface of said at least one window pane faces the outside to a second position wherein said at least one window pane is parallel to said aperture defined by said window frame and said second surface of said at least one window pane faces the outside, said window pane assembly being further rotatable from said second to said first position; and
c) a seal assembly comprising a seal frame and at least one pliable seal carried by and exteriorly positioned with respect to said seal frame, said seal assembly being located on the inside with respect to said fixed frame and sealing said aperture from the inside, being hingedly supported in said fixed frame, and being pivotally displaceable independently of the position of said window pane assembly from a closed position in which said seal frame is parallel and adjacent to said aperture defined by said interior surface of said fixed frame to an open position in which said seal frame is spaced from and at an angle to said aperture.

2. The window apparatus of claim 1, further comprising a glazing unit hingedly attached to the window pane assembly, said glazing unit being provided with at least one pane of glass parallel to, when in a closed position, and having different optical properties than the at least one pane carried by the window pane assembly, whereby said glazing unit is rotatable together with the window pane assembly so that said glazing unit is exteriorly disposed at said first position and interiorly disposed at said second position relative to the at least one pane carried by the window pane assembly.

3. The window apparatus of claim 2, wherein the at least one pane of glass provided with the glazing unit is capable of absorbing 30-90 percent of the energy of the incoming solar radiation at a wavelength between 0.3-4 microns and is nearly opaque to a wavelength greater than 4 microns.

4. The window apparatus of claim 3, wherein 30-90 percent of the energy of the incoming solar radiation is prevented from being transmitted to the inside at the first position of the window pane assembly.

5. The window apparatus of claim 2, wherein at least one gap is formed between the at least one pane carried by the window pane assembly and the at least one pane of glass provided with the glazing unit, whereby heated air is able to circulate through said gap, at the second position of the window pane assembly, into an enclosure proximate to the window apparatus.

6. The window apparatus of claim 1, further comprising an actuator, said actuator in communication with the axle(s) of the window pane assembly, whereby to facilitate remote rotation of the latter.

7. The window apparatus of claim 2, further comprising a microprocessor, said microprocessor operative to receive input from sensors disposed at predetermined locations relative to the window pane assembly, whereby the microprocessor transmits a signal to an actuator in communication with the axle(s) of the window pane assembly to facilitate rotation of the window pane assembly from the first position to the second position, or vice versa, in response to predetermined sensed conditions of illumination and/or temperature.

8. A method of repositioning a window pane assembly, comprising providing a window pane assembly which carries at least one window pane and which is rotatable with respect to a fixed frame; providing a mounting for a water impermeable sealing element hingedly attached to the interior of the frame; opening said mounting; applying a force to said window pane assembly to thereby displace the latter from a first position at which one side of said at least one window pane is parallel to and facing a plane formed by the exterior of the frame to a second position at which the other side of said at least one window pane is parallel to and facing a plane formed by the frame exterior, or from said second position to said first position; and closing said mounting.

9. This method of claim 8, wherein the at least one window pane carried by the window pane assembly can be washed indoors, such that one side of the least one window pane is washable at the first position of the window pane assembly and the other side of the at least one window pane is washable at the second position.

10. The method of claim 8, wherein the window pane assembly is manually rotatable.

11. The method of claim 8, wherein the window pane assembly is remotely rotated by an actuating means.

12. The method of claim 8, further comprising providing a glazing unit hingedly attached to the window pane assembly and which is provided with at least one pane of glass parallel to when in a closed position and having different optical properties than the at least one pane carried by the window pane assembly and rotating said glazing unit when in a closed position, together with the window pane assembly, from the first position of the window pane assembly to the second position, or vice versa.

13. The method of claim 12, wherein the glazing unit is exteriorly disposed at a first position during a summer mode and interiorly disposed during a winter mode at a second position relative to the at least one pane carried by the window pane assembly.

14. The method of claim 13, wherein the at least one pane of glass provided with the glazing unit is heated by solar radiation and subsequently releases energy to the inside during the winter mode by long-wave radiation or by convective heating.

15. The method of claim 13, wherein energy absorbed by the at least one pane of glass provided with the glazing unit is released to the outside during the summer mode by convection or by long wave radiation.

16. The method of claim 12, wherein the window pane assembly is rotated by means of a microprocessor to facilitate rotation of the window pane assembly from the first position to the second position, or vice versa, in response to predetermined sensed conditions of illumination and/or temperature.
